(19) United States
(12) Patent Application Publication
(10) Pub. No.: US 2007/0119888 A1
(43) Pub. Date: May 31, 2007

(54) MOUNT ADJUSTABLE TO VARIOUS TUBES

(76) Inventor: Louis Chuang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/164,552

(22) Filed: Nov. 29, 2005

(51) Int. Cl. B62J 9/00; B62J 7/00; B62J 11/00

(52) U.S. Cl. 224/427

(57) ABSTRACT

Disclosed is a mount for installing an accessory to a bicycle. The mount includes a first body to which the accessory is connected. The first body defines two apertures and a channel in communication with the apertures. The width of the channel is smaller than the diameter of the apertures. A second body is pivotally connected to the first body, and defines an aperture. A pin is inserted in the aperture of the second body and selective one of the apertures of the first body. The pin includes two flat sides and two convex sides. The distance between the flat sides is about the width of the channel. The distance between the convex sides is about the diameter of the apertures. The pin cannot move between the apertures through the channel in a position but can do in another position. A fastening device causes the bodies to clamp the bicycle.

### BACKGROUND OF INVENTION

1. Field of Invention

The present invention relates to a mount for installing an accessory on a bicycle and, more particularly, to a mount adjustable to various tubes, i.e., tubes with various diameters.

2. Related Prior Art

Disclosed in Taiwanese Patent Publication No. 570002 is a quick-release mount for installing an accessory to a bicycle. The mount includes a body 20, a quick-release element and a strap 24. On the body 20 is formed a connecting portion 205 to which an accessory such as a mudguard can be connected. The quick-release element includes a first strip 21 pivotally connected to the body 20, a second strip 22 pivotally connected to the first strip 21 and a third strip 23 pivotally connected to the second strip 22. Formed on the third strip 23 is a buckle 232 for pinching the strap 24. Connected to the strap 24 is a ring 243 for holding on to a hook 203 formed on the body 20. The body 20, the quick-release element and the strap 204 can be wound around a seat tube of a bicycle for example. The ring 243 can be hooked on the hook 203. Now, the body 20, the quick-release element and the strap 204 together make a loop around the seat tube. The quick-release element can be folded so that the loop binds the seat tube. The pinching of the strap 24 by means of the buckle 232 is however not reliable so that the mudguard often slides down the seat tube and finally interferes with the rolling of a wheel.

The present invention is therefore intended to obviate or at least alleviate the problems encountered in prior art.

### SUMMARY OF INVENTION

According to the present invention, a mount is disclosed for installing an accessory to a tube of a bicycle. The mount includes a first body to which the accessory is connected. The first body defines two apertures and a channel in communication with the apertures. The width of the channel is smaller than the diameter of the apertures. A second body is pivotally connected to the first body, and defines an aperture. A pin is inserted in the aperture of the second body and selective one of the apertures of the first body. The pin includes two flat sides and two convex sides. The distance between the flat sides is about the width of the channel. The distance between the convex sides is about the diameter of the apertures. The pin cannot move between the apertures through the channel in a position but can do in another position. A fastening device causes the bodies to clamp the bicycle.

The primary advantage of the mount of the present invention is its reliable operation because the insertion of the pin in selective one of the apertures retains the mount in selective one of a plurality of sizes.

Other objectives, advantages and novel features of the present invention will become more apparent from the following detailed description referring to the attached drawings.

### BRIEF DESCRIPTION OF DRAWINGS

The present invention will be described through illustration of the preferred embodiment referring to the drawings.

FIG. 1 is a perspective view of a mount adjustable to various tubes of bicycles according to the preferred embodiment of the present invention.

FIG. 2 is an exploded view of the mount shown in FIG. 1.

FIG. 3 is a cross-sectional view of the mount taken along a line 3-3 in FIG. 1.

FIG. 4 is a cross-sectional view of the mount in another position than that is shown in FIG. 3.

FIG. 5 is a cross-sectional view of the mount in another position than that is shown in FIG. 4.

FIG. 6 is a cross-sectional view of the mount in another position than that is shown in FIG. 5

FIG. 7 is a side view of a bicycle on which a mudguard is installed by means of the mount shown in FIG. 1.

FIG. 8 is a side view of a bicycle on which a rack is installed by means of the mount shown in FIG. 1.

FIG. 9 is a side view of a bicycle on which a bag is installed by means of the mount shown in FIG. 1.

### DETAILED DESCRIPTION OF PREFERRED EMBODIMENT

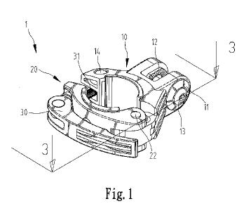

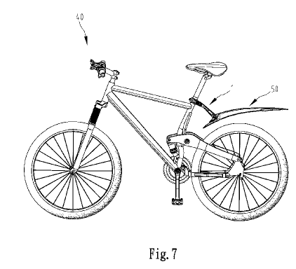

Referring to FIG. 1, there is shown a mount 1 for installing an accessory to a bicycle such as those shown in FIGS. 7 through 9 according to the preferred embodiment of the present invention. The mount 1 is adjustable to various tubes of bicycles, i.e., tubes with various diameters.

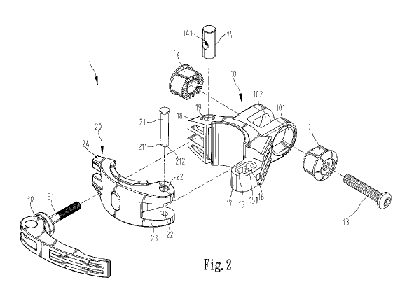

Referring to FIG. 2, the mount 1 includes a first body 10, a second body 20 pivotally connected to the first body 10 in selective one of a plurality of positions and a fastening device 30 for causing the bodies 10 and 20 to clamp a seat tube for example.

Two lugs 101 and 102 are formed on a convex (or “external”) side of the first body 10. Two jaws 11 and 12 are non-rotationally installed on the lugs 101 and 102. A lug formed on an accessory can be put between the jaws 11 and 12. A fastener 13 can be driven in the jaws 11 and 12 in order to cause the jaws 11 and 12 to clamp the lug formed on the accessory. The jaws 11 and 12 both include a plurality of teeth (not numbered). The lug formed on the accessory includes two sides both formed with a plurality of teeth for engagement with the teeth of the jaws 11 and 12, thus keeping the accessory in selective one of a corresponding number of positions relative to the mount 1.

A lug 17 and two lugs 18 are formed on a concave (or “internal”) side of the first body 10. The lug 17 and the lugs 18 are located at opposite ends of the first body 10. The lug 17 defines a first aperture 15, a second aperture 16 and a channel 151 through which the first aperture 15 is in communication with the second aperture 16. The width of the channel 151 is smaller than the diameter of the apertures 15 and 16. Each of the lugs 18 defines an aperture 19.

The second body 20 includes two lugs 23 and two lugs 24 located opposite to the lugs 23. Each of the lugs 23 defines an aperture 22.

The fastening device 30 is preferably a quick-release device including a threaded bolt 31.

A column-shaped nut 14 defines a screw hole 141 for receiving the threaded bolt 31.

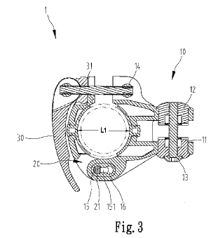

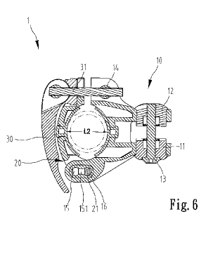

In assembly, the lug 17 is put between the lugs 23. A pin 21 is inserted in the apertures 22 and the aperture 15 referring to FIG. 3 or the aperture 16 referring to FIG. 6. The threaded bolt 31 is driven in the screw hole 141 between the lugs 18.

Referring to FIG. 3, the pin 21 is inserted in the aperture 15 so that the bodies 10 and 20 can clamp a tube with a diameter L1.

Referring to FIG. 6, the pin 21 is inserted in the aperture 16 so that the bodies 10 and 20 can clamp a tube with a smaller diameter L2.

To allow the movement of the pin 21 between the apertures 15 and 16 without having to pull the pin 21 from them, the channel 151 is defined and the pin 21 is made with a special form. The pin 21 includes an oblong cross-sectional profile. The pin 21 includes two flat sides 211 and two convex sides 212 between the flat sides 211. The distance between the flat sides 211 is marginally smaller than the width of the channel 151. The distance between the convex sides 212 is marginally smaller than the diameter of the apertures 15 and 16. That is, the distance between the flat sides 211 is smaller than the distance between the convex sides 212. The apertures 22 are made in compliance with the pin 21 so that the second body 20 and the pin 21 rotate together as the second body 20 receives the pin 21.

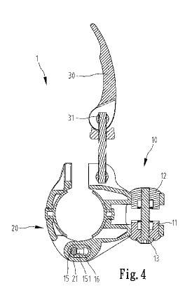

Referring to FIG. 4, the fastening device 30 is pivoted from the second body 20 and, more particularly, the lugs 24. The pin 21 cannot move between the apertures 15 and 16 through the channel 151.

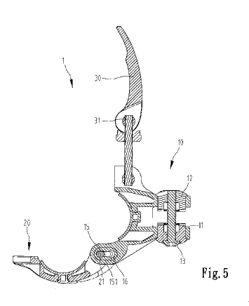

Referring to FIG. 5, the second body 20 is pivoted on the first body 10 so that the pin 21 is pivoted in the aperture 15. The pin 21 can move between the apertures 15 and 16 through the channel 151.

Referring to FIG. 7, a mudguard 50 is connected to a seat tube of a bicycle by means of the mount 1.

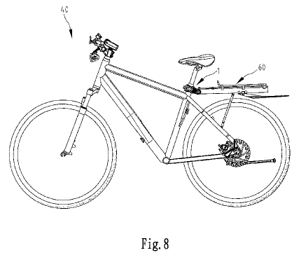

Referring to FIG. 8, a rack 60 is connected to a seat tube of another bicycle by means of the mount 1.

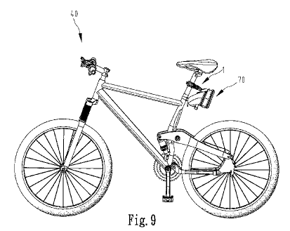

Referring to FIG. 9, a bag 70 is connected to a seat post of still another bicycle by means of the mount 1.

The diameter of the seat post of a bicycle varies from 26.0 mm to 34.9 mm. The use of the apertures 15 and 16 and the threaded bolt 31 ensure adequate adjustment of the mount 1.

The primary advantage of the mount 1 of the present invention is its reliable operation because the dimensions of the pin 21 and that of the apertures 15 and 16 and of the channel 151 retain the mount 1 in selective one of a plurality of sizes.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

What is claimed is:

1. A mount for installing an accessory to a tube of a bicycle, the mount being adjustable to various tubes and comprising:
a first body to which the accessory can be connected, wherein the first body defines at least two apertures and a channel in communication with the apertures; wherein the width of the channel is smaller than the diameter of the apertures;
a second body pivotally connected to the first body, wherein the second body defines an aperture; and
a pin for insertion in the aperture of the second body and selective one of the apertures of the first body, wherein the pin comprises two flat sides and two convex sides between the flat sides, wherein the distance between the flat sides is about the width of the channel, wherein the distance between the convex sides is about the diameter of the apertures so that the pin cannot move between the apertures through the channel in an annular position but can move between the apertures through the channel in another angular position; and
a fastening device for causing the first and second bodies to clamp the tube.

2. The mount according to claim 1 wherein the first body comprises a lug in which the apertures are defined, wherein the second body comprises two lugs in each of which the aperture is defined, wherein the lug of the first body is put between the lugs of the second body.

3. The mount according to claim 1 comprising two jaws connected to the first body in order to clamp the accessory.

4. The mount according to claim 3 wherein the first body comprises two lugs to which the jaws are connected.

5. The mount according to claim 1 wherein the fastening device comprises a threaded bolt.

6. The mount according to claim 1 wherein the fastening device comprises a quick-release device.
